(19) United States
(12) Patent Application Publication
(10) Pub. No.: US 2005/0082915 A1
(43) Pub. Date: Apr. 21, 2005

(54) Breakaway power supply device

(75) Inventor: Howard I. Steinberg, Shelton, CT (US)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: CONAIR CORPORATION

(21) Appl. No.: 10/684,962

(22) Filed: Oct. 14, 2003

(51) Int. Cl. H02G 1/00

(52) U.S. Cl. 307/147

(57) ABSTRACT

A breakaway power supply device operatively connectable to an electronic appliance either directly or indirectly via a controller is provided. The controller is used for sensing and/or controlling the operation of the appliance to which it is operatively connected. The breakaway device also has a power cord with a first connector suitable for releasably connecting with the controller and/or the appliance via a magnetic attraction. The power cord also has a second connector suitable for connecting to a power source. The magnetic attraction is suitable to withstand a predetermined or predefined disconnect force. This predetermined disconnect force may be varied as desired. The breakaway power supply device provides an effective, reliable and safe power connection for heatable electronic appliances that require continuous intimate contact with a separable controller.

### BACKGROUND OF THE INVENTION

1. Field of the Invention

The present invention generally relates to detachable power supply device operatively connectable with any of a variety of electrical appliances. More particularly, the present invention relates to a magnetic breakaway power supply device.

2. Description of the Prior Art

Detachable power supply devices are known in the art and have long been used in association with a variety of electrical appliances including, for example, fryers, cookers, skillets, griddles, fondues, woks, popcorn poppers and others. U.S. Pat. Nos. 2,856,489, 2,926,230, and 3,019,320 provide examples of such conventional detachable power supply devices. U.S. Pat. Nos. 6,250,931, 6,267,602, and 6,607,391 provide further examples of alternative detachable power supply devices.

In order for these detachable power supply devices to be effective, it is necessary to balance the need for maintaining an appropriate continuous intimate contact with the appliance, typically via a complementary connector, against the need for safety and protection against inadvertent injury resulting from accidental contact with the appliance during operation, via a kick or pull of the power cord. Accordingly, there is a need for providing an effective, convenient, reliable and safe breakaway power supply device suitable for use with various appliances and more particularly with those appliances that are heatable and/or require temperature controllers.

### SUMMARY OF THE INVENTION

It is an object of the present invention to provide an improved breakaway power supply device.

It is another object of the present invention to provide an improved breakaway power supply device that is operatively connectable to a temperature controller and/or an electronic appliance.

It is still another object of the present invention to provide an improved breakaway power supply device that can be adjusted or varied to cooperate with a variety of different appliance power input requirements.

It is yet another object of the present invention to provide an improved breakaway power supply device that optimally disconnects a source of power from an appliance upon application of a predefined action.

It is a further object of the present invention to provide an improved breakaway power supply device that connects to an appliance and/or a temperature controller via a magnetic force.

It is still a further object of the present invention to provide an improved breakaway power supply device that uses a magnetic force which can be adjusted or varied to provide a desired connection force.

It is a yet still a further object of the present invention to provide an improved breakaway power supply device that is effective, convenient, and reliable for its intended purpose.

These and other objects and advantages of the present invention are achieved by a breakaway power supply device operatively connectable to any of a variety of appliances. The breakaway device has a controller for controlling or manipulating the operation of the appliance, and a power cord with at least two connectors. Preferably, the power cord has, at a first end, a first connector for connecting to the controller and/or the appliance, and the power cord has, at a second end a second connector for connecting to a power source.

### BRIEF DESCRIPTION OF THE DRAWINGS

Other and further objects, advantages and features of the present invention will be understood by reference to the following specification in conjunction with the accompanying drawings, in which like reference characters denote like elements of structure.

FIG. 1 is a front perspective view of a breakaway power supply device in accordance with an illustrative embodiment of the present invention;

FIG. 2 is an exploded perspective view of a preferred aspect of the break away power supply device of FIG. 1; and

FIG. 3 is section plan view of the breakaway power supply device of FIG. 1.

### DETAILED DESCRIPTION OF THE INVENTION

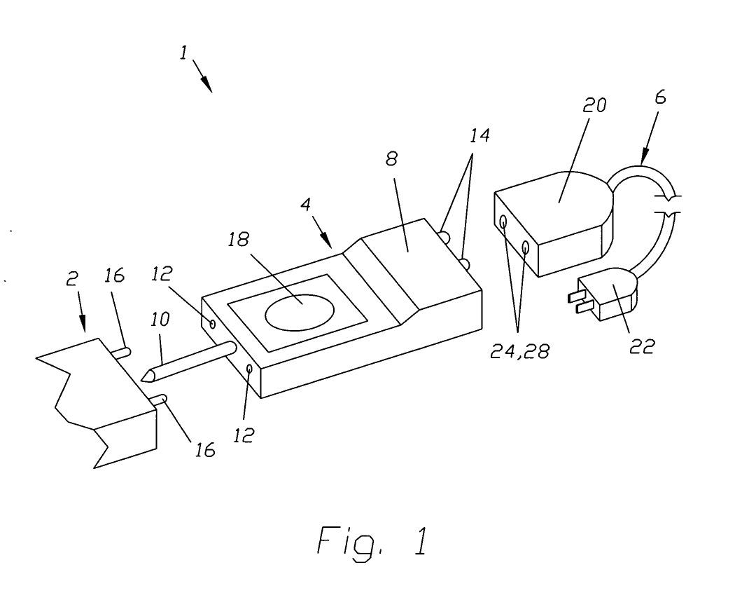

Referring to the drawings and in particular to FIG. 1, there is shown an illustrative embodiment of an improved breakaway power supply device generally represented by reference numeral 1. The breakaway device 1, in one aspect of the present invention, preferably operates with an appliance 2, and more particularly, with an electrically heatable appliance, such as, for example, a fryer, a cooker, a skillet, a griddle, a fondue, a wok, or a popcorn popper. Breakaway device 1 can have a controller 4 suitable for operatively connecting to appliance 2. Breakaway device 1 can also have a power cord 6 suitable for operatively connecting to controller 4 and/or appliance 2, as well as to a power source.

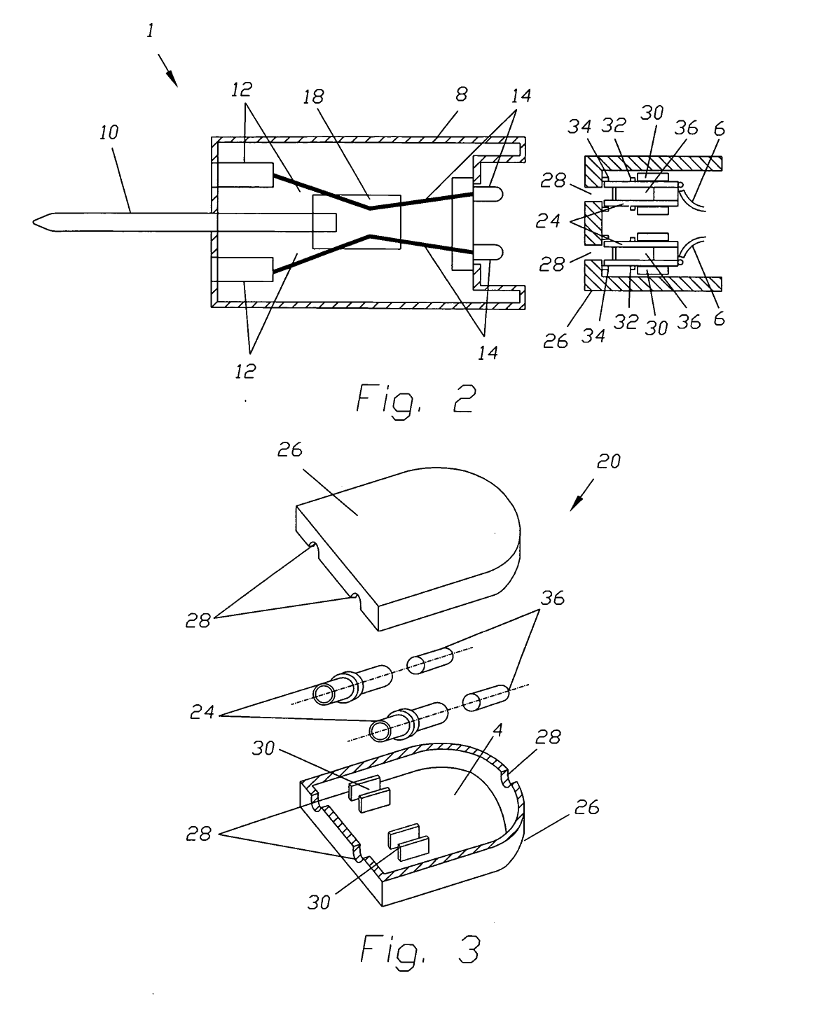

Referring to FIGS. 1 and 2, controller 4 preferably has a housing 8 with a probe or sensor 10, one or more conductive controller outputs 12, and one or more conductive controller inputs 14. Preferably, controller 4 can be operatively connected to one or more conductive appliance inputs 16 via controller outputs 12. Appliance inputs 16 are preferably complementary in shape, size and/or configuration to controller outputs 12. Preferably, controller outputs 12 and appliance inputs 16 cooperate to provide a safe, effective electrical and/or mechanical connection therebetween.

Preferably, controller 4 can directly and/or indirectly control any of the various operations of appliance 2. For example, controller 4 can be a temperature controller suitable for controlling the operating temperature of the appliance. In one aspect of the present invention, sensor 10 is suitable for interacting with appliance 2 to facilitate operative communication between controller 4 and appliance 2. In another aspect of the present invention, a user interface 18 is provided on housing 8 that operatively cooperates with sensor 10 and enables a user to adjustably control the operation (e.g., temperature, etc.) of appliance 2. Sensor 10 may be of any size, shape and/or configuration suitable for cooperating with controller 4 and/or appliance 2.

Referring to FIG. 1, in a preferred aspect of the present invention, power cord 6 has a first connector 20 preferably suitable for operatively connecting to controller 4 and/or appliance 2, and a second connector 22 preferably suitable for operatively connecting to a power source (not shown). First connector 20 and second connector 22 preferably cooperate to selectively provide power to controller 4 and/or appliance 2 via power cord 6.

Referring to FIGS. 2 and 3, first connector 20 preferably has one or more conductive connector outputs 24 suitable to selectively engage/disengage controller inputs 14 and/or appliance inputs 16. As shown, connector outputs 24 are preferably in a protective casing 26 with one or more access apertures 28 therein. Access apertures 28 preferably enable controller inputs 14 and/or appliance inputs 16 to operatively connect to connector outputs 24. Access apertures 28 also preferably enable power cord 6 to be operatively connected to connector outputs 24. Casing 26 can have any of a variety of shapes, sizes and/or configurations suitable to protect the integrity of connector outputs 24.

As best shown in FIG. 3, in a preferred aspect of the present invention, connector outputs 24 are hollow cylinders preferably made of an electrically conductive ferrous type material. Connector outputs 24 preferably cooperate with casing 26 via one or more channels 30. These channels 30 are preferably integral to casing 26. In this aspect of the present invention, connector outputs 24 have one or more ribs 32 that preferably cooperate with channels 30 to securely hold connector outputs 24 in position, preferably in close proximity to access apertures 28. Additional and/or alternative securing arrangements may also be used to appropriately secure the connector output contacts in the casing. For example, casing 26 may be provided with one or more optimally positioned securing tabs 34 as desired.

As shown in FIGS. 2 and 3, in a preferred aspect of the present invention, each connector output 24 has one or more magnets 36 disposed therein. This arrangement preferably protects the integrity of magnets 36 and/or creates a magnetic interaction between magnets 36 and the electrically conductive ferrous type material of connector outputs 24. In this aspect of the invention, magnets 36 are preferably formed of a samarium-colbalt alloy. However, additional and/or alternative magnetic materials may also be used. In this aspect of the invention, magnets 36 are cylindrically shaped. However, magnets 36 can have any size, shape and/or configuration suitable to effectively cooperate with connector outputs 24. As shown in FIG. 2, magnets 36 are preferably recessed in connector outputs 24 to allow controller inputs 14 and/or appliance inputs 16 to be received into the connector outputs.

It is noted that in this preferred aspect of the invention, controller inputs 14 and/or appliance inputs 16 are preferably made of an electrically conductive ferrous type material similar to connector outputs 24. Hence, controller inputs 14 and appliance inputs 16 preferable magnetically interact with magnets 36 and/or connector outputs 24.

Thus, power cord 6 can be connected to controller 4 and/or appliance 2 by advancing first connector 20 over controller inputs 14 and/or appliance inputs 16 such that the respective inputs extend into access apertures 28 and in close proximity to connector outputs 24. As first connector 20 is advanced toward controller 4 and/or appliance 2, a magnetic connection is formed between connector outputs 24 and controller inputs 14 and/or appliance inputs 16. Preferably, the magnetic connection is sufficient to maintain an effective and reliable electrical connection between first connector 20 and controller 4 and/or appliance 2, and can preferably withstand a predefined or predetermined disconnect force. The magnetic force associated with the magnetic connection can preferably be adjusted or varied as desired.

It should be apparent from the foregoing that the present invention provides for a safe, effective and efficient breakaway power supply device operable to provide a reliable electrical connection, via a magnetic attraction between two connecting elements, separably linking any of a variety of appliances to a power source. By appropriate component scaling, a wide range of current flows and/or voltages may be reliably passed through the connecting elements.

The present invention having been thus described with particular reference to the preferred forms thereof, it will be obvious that various changes and modifications may be made therein without departing from the spirit and scope of the present invention as defined herein. In addition, it is believed that the many advantages of this invention and the manner in which it fulfills the stated objectives will be understood by those skilled in the art.

1. A breakaway power supply device operatively connectable to an appliance, said device comprising:
a controller for sensing and/or controlling the temperature of said appliance; and
a power cord with a first connector for connecting said power cord to said controller and a second connector for connecting said power cord to a power source,
wherein said first connector has at least two conductive connector outputs with a magnet therein.

2. The breakaway device of claim 1, wherein said at least two connector outputs are made of a ferrous type material.

3. The breakaway device of claim 1, wherein said magnets are made of samarium colbalt.

4. The breakaway device of claim 1, wherein said controller has at least two conductive controller inputs suitable for operatively connecting to said at least two conductive connector outputs of said first connector.

5. The breakaway device of claim 4, wherein said at least two conductive controller inputs are made of a ferrous type material.

6. The breakaway device of claim 4, wherein said at least two conductive connector outputs and said at least two conductive controller inputs are electrically, magnetically and separably connectable.

7. A power supply device electrically, magnetically and separably connectable to an appliance, said device comprising:
a power supply cord with a first connector for connecting to a controller and a second connector for connecting to a power source,
wherein said first connector has one or more conductive connector outputs, each of said one or more connector outputs having a magnet disposed therein.

8. The device of claim 7, wherein said each magnet is dispose entirely inside said one or more conductive connector outputs.

9. The device of claim 8, wherein said one or more conductive connector outputs are made of a ferrous type material.

10. The device of claim 7, wherein said controller has one or more conductive controller inputs suitable for operatively connecting with said at one or more conductive connector outputs of said first connector.

11. The device of claim 10, wherein said one or more conductive controller inputs are made of a ferrous type material.

12. The device of claim 7, wherein said controller has a sensor probe for sensing the temperature of said appliance.

13. The device of claim 7, wherein said controller has one or more conductive controller inputs suitable for operatively connecting with said at one or more conductive connector outputs of said first connector, and wherein said conductive connector outputs and said conductive controller inputs facilitate electrically, magnetically and separably connecting said appliance to said power supply.

14. The device of claim 13, wherein said first connector is separable from said controller upon application of a predetermined disconnecting force.

15. The device of claim 14, wherein said predetermined disconnecting force is dependent on the magnetic force of said magnets.

16. The device of claim 15, wherein said magnetic force is adjustable.

17. A power supply cord comprising:
a first connector for connecting to a power source; and
a second connector for connecting to a controller, said controller operatively connectable to an electrical appliance,
wherein said second connector and said controller electrically and magnetically interact via a plurality of conductive contacts.
